(19) United States
(12) Patent Application Publication
(10) Pub. No.: US 2024/0390227 A1
(43) Pub. Date: Nov. 28, 2024

(54) HEALTH CARE RELAXATION AND SOOTHING APPARATUS

(71) Applicant: Hui-Chih WANG, Yilan City (TW)

(72) Inventors: Hui-Chih WANG, Yilan City (TW); Hsien-Chang KO, Yilan City (TW)

(21) Appl. No.: 18/661,109

(22) Filed: May 10, 2024

(30) Foreign Application Priority Data
May 26, 2023 (TW) 112205318

(51) Int. Cl. A61H 39/06; A61H 39/00

(52) U.S. Cl. CPC A61H 39/06; A61H 2039/005; A61H 2201/0207; A61H 2201/165; A61H 2201/5012; A61H 2201/5082

(57) ABSTRACT

A health care relaxation and soothing apparatus providing a control area on the base member of the control host, a control circuit system set in the base member and provided with an electrical connector on the lateral side of the base member and plug-in connectors surrounding the control area, and a storage space formed outside each plug-in connector for a plurality of skin-friendly attachments to be inserted into or removed from each storage space. Each skin-friendly attachment has a circuit unit inside, a light projection area on the surface of one side thereof and electrically connected to the circuit unit, a heat-transmitting area, a docking connector and a sensing unit located around the light projection area. This design achieves the purpose of providing the human body with relaxation and soothing.

This application claims the priority benefit of Taiwan patent application number 112205318, filed on May 26, 2023.

### BACKGROUND OF THE INVENTION

### 1. Field of the Invention

The invention relates to a health care relaxation and soothing apparatus, especially a relaxation and soothing apparatus applied to human skin, which has a plurality of skin-friendly attachments installed at a control host, and the skin or acupuncture points of human body are irradiated and massaged through at least one or more light projection areas and a plurality of heat-transmitting areas of each skin-friendly attachment, so as to relax and soothe the human body.

### 2. Description of the Related Art

In people's daily life, various body movements such as housework, work or leisure activities will lead to weakened body functions, physical exertion, fatigue, burnout and other phenomena. In addition to rest, people usually use auxiliary devices such as massage and physical therapy to help the body eliminate fatigue and restore physical strength. In addition, methods such as hot compress or electrotherapy are used to attach patches or wearable devices of auxiliary devices to the human skin. By means of heat energy, electric current or vibration, thermal energy, electric energy or magnetic waves are used to stimulate, contract and stretch human skin and muscles, so as to soothe and relax human skin, achieve the effects of eliminating fatigue and restoring body functions.

Most of the auxiliary devices that are generally applied to human skin for massage, physical therapy mostly use the principle of far-infrared rays, magnetism or current stimulation, etc. to allow far-infrared rays, currents, magnetic waves, etc. to penetrate into human skin, muscles, tendons and bones to stimulate the tendons and muscles. However, most of the current used massage and physical therapy devices use wired methods to electrically connect the patches or wearable devices of the auxiliary therapy devices to the control host, and use the control host to drive patches or wearable devices to perform massage, physical therapy, etc. on the human body. However, this kind of auxiliary device only has a single use function, and the application mode is fixed and cannot be changed or transformed. It can only use a single physical therapy method to massage or stimulate the human body. If other treatment modes are needed, auxiliary devices with multiple different functions must be provided, which not only causes inconvenience during application, but also requires more expenses in purchasing auxiliary devices. In actual application or implementation, there are deficiencies that need to be improved.

Therefore, how to solve the problems and inconveniences of auxiliary devices used in massage or physical therapy that can only use a single mode to assist physical therapy, and the auxiliary devices must be used in a wired manner, that is the direction that relevant manufacturers in this industry are eager to study and improve.

### SUMMARY OF THE INVENTION

Therefore, in view of the above-mentioned problems and deficiencies, the inventor collected relevant information, evaluated and considered it from many parties, and used his many years of experience in this industry to design this kind of health care relaxation and soothing through continuous creation and modification.

It is the main object of the present invention that the health care relaxation and soothing apparatus is provided with a control area on the surface of the base member of the control host, and the control circuit system provided inside the base member is provided with at least one electrical connector on at least one lateral side of the base member and a plurality of plug-in connectors on the surface surrounding the control area, and a storage space is formed on the outside of each plug-in connector for a plurality of skin-friendly attachments to be inserted into or removed from each storage space. Each skin-friendly attachment comprises a circuit unit inside, at least one or more light projection areas located on the surface of one side thereof and electrically connected to the circuit unit, and a plurality of heat-transmitting areas located around the at least one or more light projection areas, at least one docking connector and at least one sensing unit respectively located on the surface of one side of each skin-friendly attachment. It achieves the purpose of providing relaxation and soothing to the human body and it is not constrained by wires during application, making it easier and more convenient.

Another object of the present invention is that a hollow accommodation space is provided inside the base member of the control host for installing the control circuit system, and the at least one electrical connector and plug-in connectors of the control circuit system and the docking connectors of the plurality of skin-friendly attachments can respectively be power connectors, or signal connectors of different types, such as USB connectors, Type-C connectors, magnetic connectors or PogoPin connectors.

Still another object of the present invention is that the plurality of skin-friendly attachments are selectively repeatable adhesive patches (hook and loop fastener), adhesive patches, elastic straps, straps, or self-adhesive magnetic fixation straps made of graphene, germanium ions, quantum or ceramic fiber yarn fabrics. Each the heat-transmitting area of each skin-friendly attachment can selectively be a radio frequency emitter, ultrasonic emitter, far infrared emitter, electric heater, energy stone or magnetic stone, and the at least one or more light projection areas of each skin-friendly attachment can be used for projecting multi-band laser light or multi-band LED light sources or light waves.

Still another object of the present invention is that the sensing unit of the plurality of skin-friendly attachments is selectively a photoresistor or thermal sensor, each skin-friendly attachment further comprises a touch switch and a status indication area respectively and electrically connected to the circuit unit of each skin-friendly attachment and selectively arranged on the same side, different side surfaces or peripheral sides of each respective skin-friendly attachment, which status indication area can use light brightness, color changes or sound changes (long sound, short sound or voice notifications, etc.) to display various usage states such as power on, power off or execution of application tasks), and the touch switch and status indication area on the control host can be controlled through wireless transmission methods, such as Bluetooth, Wi-Fi, RFID, Zig-bee, near field communication (NFC) or Wireless broadband network to control and display the application modes of each skin-friendly attachment. In addition, the touch switch and the status indication area can also be provided on the surface or any lateral sides of the control host and respectively and electrically connected to the control circuit system.

Still another object of the present invention is that the control circuit system is equipped with a wireless transmission device selected from the group of Bluetooth, Wi-Fi, RFID, Zig-bee, near field communication and wireless broadband network, and is selectively connected to an external preset host (such as a computer host, server, laptop, smart phone or tablet, etc.) through the wireless transmission device in a wireless manner or through the electrical connector in a wired manner to download the applications, control programs, customized treatment programs or application treatment setting operations required for the control circuit system of the control host.

### BRIEF DESCRIPTION OF THE DRAWINGS

FIG. 1 is a three-dimensional appearance view of the control host of the present invention.

FIG. 2 is a three-dimensional appearance view of the skin-friendly attachment of the present invention.

FIG. 3 is a three-dimensional exploded view of the present invention.

FIG. 4 is a three-dimensional exploded view of the preferred embodiment of the present invention.

FIG. 5 is a three-dimensional appearance view of the preferred embodiment of the skin-friendly attachment of the present invention.

FIG. 6 is a three-dimensional exploded perspective view of the preferred embodiment of the present invention.

FIG. 7 is a three-dimensional exploded perspective view of another embodiment of the present invention.

FIG. 8 is a schematic diagram of the preferred use of the skin-friendly attachment of the present invention.

### DETAILED DESCRIPTION OF THE PREFERRED EMBODIMENT

In order to achieve the above objects and effects, the technical means and structures adopted by the present invention are described in detail below with respect to the preferred embodiments of the present invention in companying with the drawings, so as to facilitate a complete understanding.

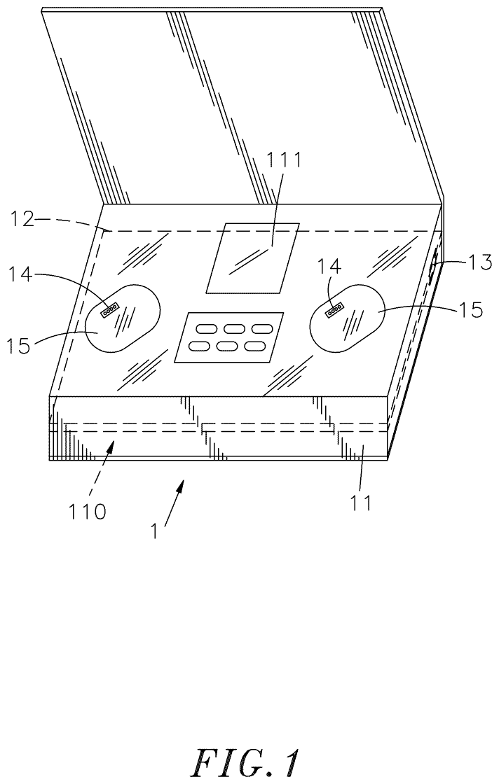

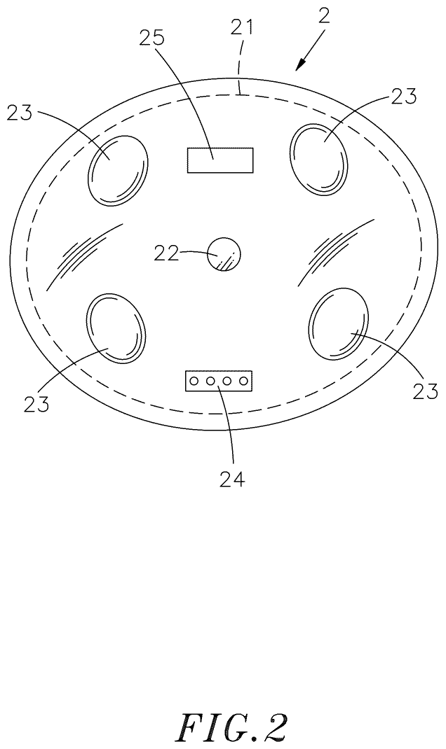

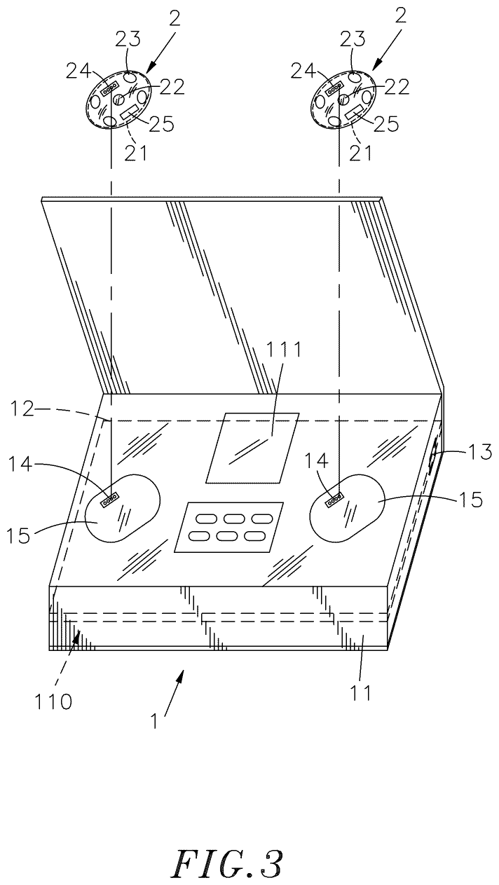

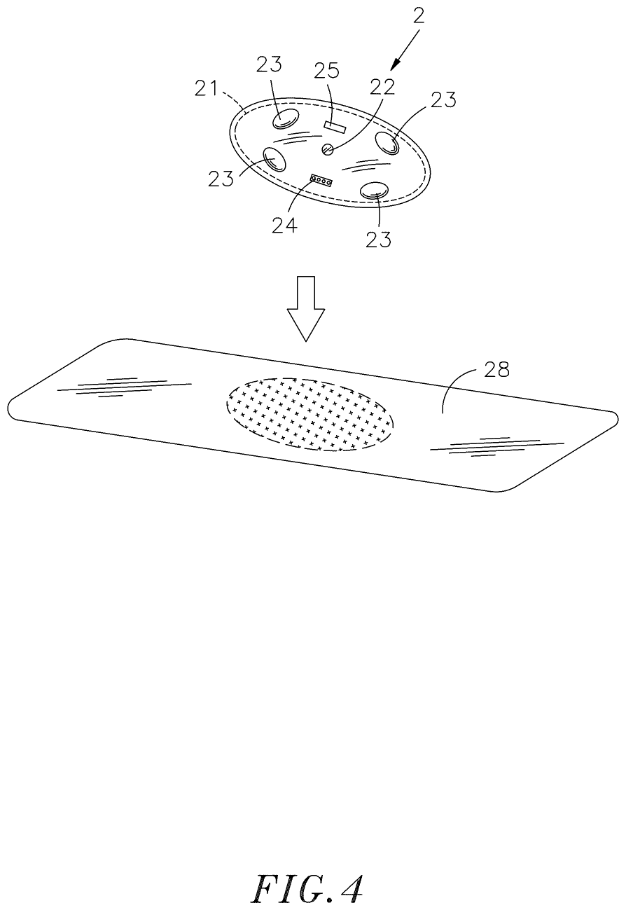

Please refer to FIGS. 1-7, which are three-dimensional appearance view of the control host of the present invention, three-dimensional appearance view of the skin-friendly attachment of the present invention, three-dimensional exploded view of the present invention, three-dimensional exploded view of the preferred embodiment of the present invention, three-dimensional appearance view of the preferred embodiment of the skin-friendly attachment of the present invention, three-dimensional exploded perspective view of the preferred embodiment of the present invention and three-dimensional exploded perspective view of another embodiment of the present invention. As shown in the drawings, it can be clearly seen that the health care relaxation and soothing apparatus of the present invention comprises a control host 1 and a plurality of skin-friendly attachments 2.

The control host 1 comprises a base member 11, a control area 111 located on an upper surface of the base member 11, an accommodation space 110 provided inside the base member 11, a control circuit system 12 set in the accommodation space 110, at least one electrical connector 13 located at least one side of the base member 11 and electrically connected to the control circuit system 12, a plurality of plug-in connectors 14 (which can be at least two or more) located at the peripheral surface of the control area 111 of the base member 11 and electrically connected to the control circuit system 12, and a storage space 15 (which can be at least two or more) is formed on the outside of each plug-in connector 14.

The plurality of skin-friendly attachments 2 can be inserted into or removed from each storage space 15 (can be at least two or more) of the control host 1. Each skin-friendly attachment 2 (can be at least two or more) comprises a circuit unit 21 inside, at least one or more light projection areas 22 located on the surface of one side of each skin-friendly attachment 2 and electrically connected to the circuit unit 21, a plurality of heat-transmitting areas 23, at least one docking connector 24 and at least one sensing unit 25 located around the at least one or more light projection areas 22.

The above-mentioned base member 11 of the control host 1 can be provided with a hollow accommodation space 110 inside for setting the control circuit system 12, and the control circuit system 12 can have a circuit layout and be equipped with a rechargeable battery (or storage battery). The at least one electrical connector 13 and plug-in connector 14 electrically connected to the control circuit system 12 and the docking connectors 24 electrically connected to the circuit unit 21 of the plurality of skin-friendly attachments 2 can respectively be power connectors or various types of signal connectors such as USB connectors, Type-C connectors, magnetic connectors or PogoPin connectors. The base member 11 of the control host 1 and the plurality of skin-friendly attachments 2 can also be charged through wireless charging, and the rechargeable battery can be used to provide the power required by the control circuit system 12 and each plug-in connector 14 or perform electronic signal transmission. The control area 111 provided on the surface of the base member 11 can be a touch panel or a resistive panel, and has functions such as light emitting, bright display or display (liquid crystal display or LED display).

The plurality of skin-friendly attachments 2 mentioned above can be repeatable adhesive patches (hook and loop fastener), adhesive patches, or straps made of materials such as graphene, germanium ions, quantum or ceramic fiber yarn fabrics, or self-adhesive magnetic fastening straps. Each heat-transmitting area 23 of the plurality of skin-friendly attachments 2 can be a radio frequency emitter, ultrasonic emitter, far infrared emitter, electric heater, energy stone or magnetic stone, etc. that can generate heat energy, temperature, etc. The at least one or more light projection areas 22 of the plurality of skin-friendly attachments 2 are capable of projecting multi-band laser light, multi-band LED light sources or other light sources, light waves, etc. The sensing unit 25 of each skin-friendly attachment 2 can be a photoresistor or a thermal sensor.

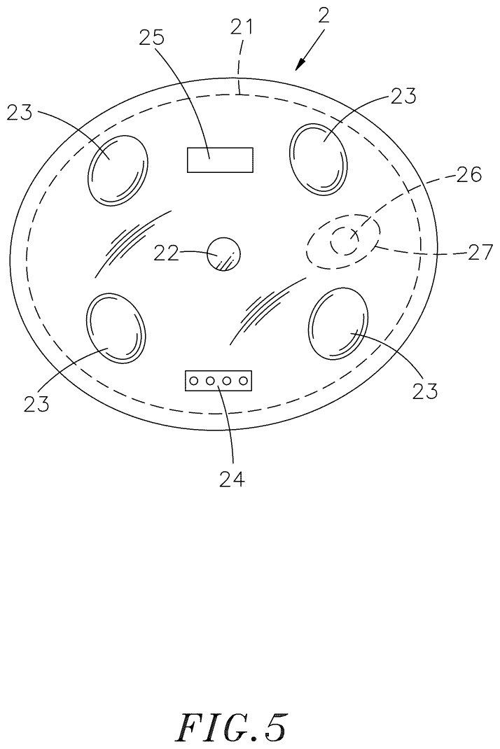

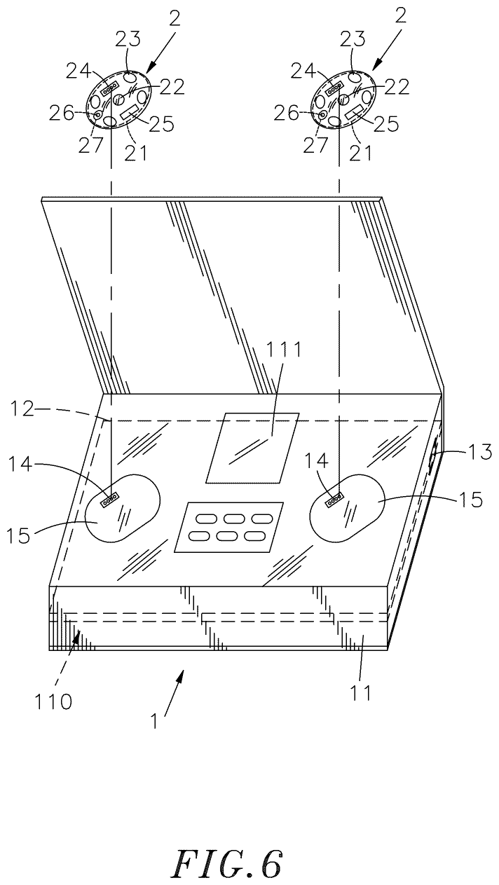

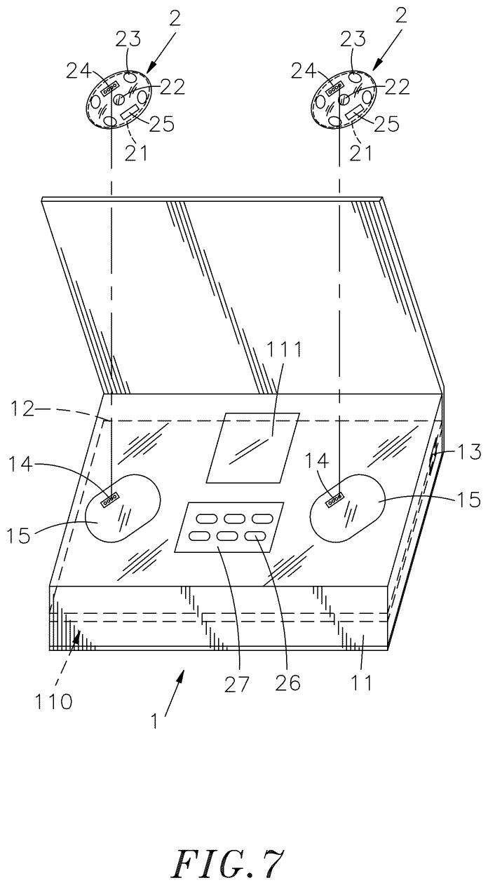

Each skin-friendly attachment 2 can be further provided with a touch switch 26 and a status indication area 27 respectively and electrically connected to the circuit unit 21 (see FIGS. 5 and 6). The touch switch 26 and the status indication area 27 can be respectively located on the same side surface, different side surfaces or peripheral sides of each skin-friendly attachment 2. The operation of each skin-friendly attachment 2 can be directly controlled through each touch switch 26, and each status indication area 27 can display the usage status of each skin-friendly attachment 2. The touch switch 26 and the status indication area 27 can also be arranged on the surface or any lateral sides of the control host 1 (see FIG. 7). The user can control and display the application modes of each skin-friendly attachment 2 by controlling the touch switch 26 and the status indication area 27 on the control host 1 through wireless transmission (such as Bluetooth, Wi-Fi, RFID, Zig-bee, near field communication (NFC) or wireless broadband network). The above-mentioned status indication area 27 can use various methods such as light brightness, color changes or sound changes (long, short tone or voice instructions, etc.) to display different usage conditions such as power on, power off or execution of application operations of each skin-friendly attachment 2.

The above-mentioned control host 1 and the plurality of skin-friendly attachments 2 of the present invention can be electrically connected to the power supply (it can be mains electric power, storage battery or power generator, etc.) to charge the rechargeable battery built in the control circuit system 12 of the base member 11 by using the at least one electrical connector 13 on the side of the base member 11 of the control host 1 during actual application and implementation. And each storage space 15 of the base member 11 is for each skin-friendly attachment 2 to be inserted into, and the docking connector 24 of each skin-friendly attachment 2 is electrically connected to the plug-in connector 14 in each storage space 15 respectively, so that the circuit unit 21 is charged by the rechargeable battery through the plug-in connector 14 and the docking connector 24 of each skin-friendly attachment 2. Each circuit unit 21 may also have a built-in rechargeable battery (or storage battery) and a circuit layout to provide the electric energy required by the at least one or more light projection areas 22, each heat-transmitting area 23, the sensing unit 25 and the status indication area 27.

In addition, the above-mentioned control host 1 has the control circuit system 12 installed in the accommodation space 110 inside the base member 11. The control circuit system 12 can be charged by using the at least one electrical connector 13 on the side of the base member 11, and it can also be connected to an external preset host (such as a computer host, a server, a notebook computer, a smart phone or a tablet, etc.) by using the at least one electrical connector 13 to download the applications, control programs, customized treatments or various application treatments required by the control circuit system 12 of various control hosts 1. The control circuit system 12 can be equipped with a wireless transmission device, such as Bluetooth, Wi-Fi, RFID, Zig-bee, near field communication (NFC) or wireless broadband network, etc., or it can use the at least one electrical connector 13 to connect to an external preset host (such as a computer host or server, etc.) through wired means to download the applications, control programs, customized treatments or various application treatments required by the control circuit system 12 of various control hosts 1.

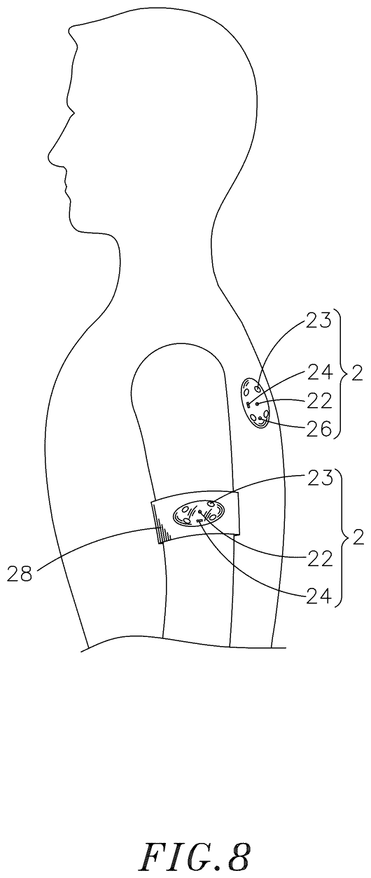

Please refer to FIGS. 1-8. As shown in the drawings, it can be clearly seen that when the health care relaxation and soothing apparatus of the present invention is in practical applications and implementations, each skin-friendly attachment 2 (which can be at least two or more) placed inside each storage space 15 (which can be at least two or more) of the base member 11 of the control host 1 can be removed. Each skin-friendly attachment 2 can be applied alone and directly attached to the skin of the human body or limb or positioned at an acupuncture point, or each skin-friendly attachment 2 can be attached (for example: magnetic suction, hook and loop fastener, or button fastening, etc.) to a larger area expansion piece 28 (it can be repeatable adhesive patch (hook and loop fastener), adhesive patch, elastic strap or strap or self-adhesive magnetic fixing strap, etc.), and then the larger area expansion piece 28 is attached to the skin of the human body or limb or positioned at an acupuncture point. At the same time, the sensing unit is close to the skin and can be at an appropriate distance, for example: the distance between the sensing unit 25 and the skin is less than 1 centimeter (<1 cm) or without any gap. The touch switch 26 can then be controlled to start the circuit unit 21 to control the at least one or more light projection areas 22 to project light sources (such as multi-band laser light, multi-band LED light source or other light sources, light waves etc.) on the skin or acupuncture point of the human body or limb and provide different Joule numbers, adjust the intensity of the projected light source or wave band, etc. Each heat-transmitting area 23 is controlled to generate heat energy or magnetism to perform massage or physical therapy (such as hot compress, electrotherapy or magnetic shock, etc.) on the skin or acupuncture point of the human body or limb. At this time, the control area 111 of each skin-friendly attachment 2 can display the power-on state, usage state, closed state or power state of each skin-friendly attachment 2 through different color light display, digital display or text display, providing the user with the ability to pay attention to the usage conditions of each skin-friendly attachment 2, thereby facilitating the operation and use of each skin-friendly attachment 2.

When each skin-friendly attachment 2 (or expansion piece 28) is attached to the skin of the human body or limb or positioned at the acupuncture point to perform massage or physical therapy (such as hot compress, electrotherapy or magnetic shock, etc.), if each skin-friendly attachment 2 (or expansion piece 28) loosens and falls off from the skin, or is separated from the skin, the sensing unit 25 on each skin-friendly attachment 2 detects that each skin-friendly attachment 2 and the skin surface forms a larger gap or distance, for example: greater than 1.5 centimeters (>1.5 cm). The sensing unit 25 immediately transmits information to each circuit unit 21 to control the at least one or more light projection areas 22 and each heat-transmitting area 23 to stop operating. It can prevent each skin-friendly attachment 2 from having the at least one or more light projection areas 22 and each heat-transmitting area 23 continue to operate after each skin-friendly attachment 2 is detached from the skin, that is, it will not cause the at least one or more light projection areas 22 to leak out light sources, thereby avoiding unnecessary power consumption or malfunction, and achieving the purpose of each skin-friendly attachment 2 having a safety protection mechanism.

The at least one electrical connector 13 on the side of the base member 11 of the control host 1 and the wireless transmission device of the control circuit system 12 can be connected to an external remote preset host (such as a computer host, a server, a notebook computer, a smart phone or a tablet) by using a wired or wireless manner to download the applications, control programs, customized treatments or various application treatments required by the control circuit system 12 through parameter change settings (for example: application time, such as 10 minutes, 20 minutes or 30 minutes, hot compress temperature, electrotherapy frequency or magnetic shock frequency) or program control operation of the remote preset host, so as to activate the circuit unit 21 inside each skin-friendly attachment 2 attached to the skin or acupuncture point of the human body to control the at least one or more light projection areas 22 of each skin-friendly attachment 2 and each heat-transmitting area 23 to start the operation modes of performing massage or physical therapy (such as hot compress, electrotherapy or magnetic shock, etc.) on the skin or acupuncture points of the human body.

The above description is only the preferred embodiments of the present invention, and does not limit the patent scope of the present invention. Therefore, all simple modifications and equivalent structural changes made by using the description and drawings of the present invention shall be included in the patent scope of the present invention and shall be clearly stated.

To sum up, when the health care relaxation and soothing apparatus of the present invention is used, it can indeed achieve their effects and purposes. Therefore, the present invention is truly an invention with excellent practicality. In order to meet the application requirements for an invention patent, I filed the application in accordance with the law and hope that the review committee will approve the case as soon as possible to protect the inventor's hard work. If the review committee has any doubts, please feel free to send us a letter for instructions. The inventor will do our best to cooperate. We sincerely appreciate it.

What the invention claimed is:

1. A health care relaxation and soothing apparatus, comprising:
a control host comprising a base member, a control area located on the surface of said base member, a control circuit system set in said base member, at least an electrical connector located at at least one side of said base member and electrically connected to said control circuit system, a plurality of plug-in connectors located at the peripheral surface of said control area and electrically connected to said control circuit system, and a storage space formed on the outside of each said plug-in connector; and
a plurality of skin-friendly attachments respectively placed in or removed from said storage spaces of said control host, each said skin-friendly attachment comprising a circuit unit inside, at least a light projection area located on the surface of one side thereof and electrically connected to said circuit unit, a plurality of heat-transmitting areas, at least a docking connector and at least a sensing unit located around at least one said light projection area.

2. The health care relaxation and soothing apparatus as claimed in claim 1, wherein said control host further comprises a hollow accommodation space provided inside said base member for the setting of said control circuit system; at least one said electrical connector and said plug-in connectors of said control circuit system and said docking connector of each said skin-friendly attachment are respectively power connectors or signal connectors selected from the group of USB connectors, Type-C connectors, magnetic connectors and PogoPin connectors.

3. The health care relaxation and soothing apparatus as claimed in claim 1, wherein the plurality of said skin-friendly attachments are selectively repeatable adhesive patches (hook and loop fastener), elastic straps, straps, or self-adhesive magnetic fixation straps made of graphene, germanium ions, quantum or ceramic fiber yarn fabrics.

4. The health care relaxation and soothing apparatus as claimed in claim 1, wherein at least one said light projection area of each said skin-friendly attachment is used for projecting multi-band laser light or multi-band LED light sources or light waves.

5. The health care relaxation and soothing apparatus as claimed in claim 1, wherein each said heat-transmitting area of each said skin-friendly attachment is selectively a radio frequency emitter, ultrasonic emitter, far infrared emitter, electric heater, energy stone or magnetic stone.

6. The health care relaxation and soothing apparatus as claimed in claim 1, wherein said sensing unit of each said skin-friendly attachment is selectively a photoresistor or thermal sensor.

7. The health care relaxation and soothing apparatus as claimed in claim 1, wherein each said skin-friendly attachment further comprises a touch switch and a status indication area respectively arranged on the surface or any lateral sides of said control host.

8. The health care relaxation and soothing apparatus as claimed in claim 1, wherein said control host further comprises said touch switch and said status indication area selectively set on the same side, different side surfaces, or the peripheral sides of each said skin-friendly attachment.

9. The health care relaxation and soothing apparatus as claimed in claim 1, wherein said control circuit system is equipped with a wireless transmission device selected from the group of Bluetooth, Wi-Fi, RFID, Zig-bee, near field communication and wireless broadband network, and said control circuit system is connected to an external preset host (such as a computer host, server, laptop, smart phone or tablet) through the wireless transmission device in a wireless manner or through at least one said electrical connector in a wired manner to download the applications, control programs, customized treatment programs or application treatment setting operations required for said control circuit system of said control host.
